(19) United States
(12) Patent Application Publication
(10) Pub. No.: US 2009/0219793 A1
(43) Pub. Date: Sep. 3, 2009

(54) METHOD OF SETTING WRITE STRATEGY PARAMETERS, AND RECORDING AND REPRODUCING APPARATUS FOR PERFORMING THE METHOD

(75) Inventors: Hui ZHAO, Suwon-si (KR); Hyun-soo PARK, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd.,, Suwon-si (KR)

(21) Appl. No.: 12/392,309

(22) Filed: Feb. 25, 2009

(30) Foreign Application Priority Data
Feb. 28, 2008 (KR) 2008-18520

(51) Int. Cl. G11B 20/10

(52) U.S. Cl. 369/47.14; G9B/20.009

(57) ABSTRACT

A method of setting write strategy parameters includes recording predetermined data on a disk loaded in a disk drive using write strategy parameters stored in a memory; adaptively equalizing a reproduction signal obtained by reproducing the recorded predetermined data from the disk; Viterbi decoding the adaptively equalized signal using a reference level; generating an ideal reproduction signal using the predetermined data, the Viterbi decoded signal, and the reference level; detecting a difference between the adaptively equalized signal and the ideal reproduction signal; generating a selection signal using the predetermined data and the Viterbi decoded signal; processing the difference using a predetermined function to detect a write strategy feedback error; and updating the write strategy parameters stored in the memory at an address specified by the selection signal using the write strategy feedback error.

### CROSS-REFERENCE TO RELATED APPLICATIONS

This application claims the benefit of Korean Patent Application No. 2008-18520 filed on Feb. 28, 2008, in the Korean Intellectual Property Office, the disclosure of which is incorporated herein in by reference in its entirety.

### BACKGROUND OF THE INVENTION

1. Field of the Invention

Aspects of the invention relate to a method of setting write strategy parameters in a disk drive, and a recording and reproducing apparatus for performing the method.

2. Description of the Related Art

A disk drive generates a recording waveform to record information on a disk. The disk may be an optical disk, and the disk drive may be an optical disk drive. The recording waveform is generated based on write strategy parameters.

Such write strategy parameters may be set differently according to the type of disk to achieve a good recording quality. Accordingly, the disk drive typically has stored therein a different write strategy parameters corresponding to the types of disks currently available in the market, and reads write strategy parameters suitable for a type of disk currently loaded in the disk drive when data is to be recorded for use in performing a recording operation.

However, since various types of disks, such as a disk having an ultra-high density based on a super-resolution technology, are being continuously developed, it is practically impossible to store all optimum write strategy parameters for all types of disks in the disk drive. Thus, when an unknown type of disk is loaded in the disk drive, the disk drive may perform the recording operation using ones of the stored write strategy parameters having a recording condition that is most similar to the unknown type of disk. However, in this case, a good recording quality may not be achieved.

Thus, a method of setting optimum write strategy parameters for an unknown disk, such as a disk having an ultra-high density based on a super-resolution technology, using a conventional disk drive would be desirable.

### SUMMARY OF THE INVENTION

Aspects of the invention relate to a method of setting an adaptive bitwise write strategy parameters for a disk loaded in a disk drive, and a recording and reproducing apparatus for performing the method.

According to an aspect of the invention, a method of setting write strategy parameters in a disk drive is provided. The disk drive includes a memory having write strategy parameters stored therein. The method includes recording predetermined data on a disk loaded in the disk drive using the write strategy parameters stored in the memory; adaptively equalizing a reproduction signal obtained by reproducing the recorded predetermined data from the disk; Viterbi decoding the adaptively equalized signal using a reference level; generating an ideal reproduction signal using the predetermined data, the Viterbi decoded signal, and the reference level used in the Viterbi decoding; detecting a difference between the adaptively equalized signal and the ideal reproduction signal; generating a selection signal using the predetermined data and the Viterbi decoded signal; processing the difference using a predetermined function to detect a write strategy feedback error; and updating the write strategy parameters stored in the memory at an address specified by the selection signal using the write strategy feedback error.

According to an aspect of the invention, the predetermined write strategy parameters stored in the memory are indexed using a bitwise write strategy indexing method.

According to an aspect of the invention, the adaptive equalizing includes updating an equalization coefficient used in the adaptive equalizing using the ideal reproduction signal and the adaptively equalized signal.

According to an aspect of the invention, the detecting of the write strategy feedback error is performed using a finite impulse response (FIR) filter and an accumulator.

According to an aspect of the invention, a method of setting write strategy parameters in a disk drive is provided. The disk drive includes a memory having write strategy parameters stored therein. The method includes recording predetermined data on a disk loaded in the disk drive using the write strategy parameters stored in the memory; adaptively equalizing a reproduction signal obtained by reproducing the recorded predetermined data from the disk; Viterbi decoding the adaptively equalized signal using a reference level; generating an ideal reproduction signal using the Viterbi decoded signal and the reference level used in the Viterbi decoding; detecting a difference between the adaptively equalized signal and the ideal reproduction signal; generating a selection signal using the Viterbi decoded signal; processing the difference using a predetermined function to detect a write strategy feedback error; and updating the write strategy parameters stored in the memory at an address specified by the selection signal using the write strategy feedback error.

According to an aspect of the invention, a recording and reproducing apparatus includes an adaptive equalization unit to adaptively equalize a reproduction signal obtained by reproducing recorded predetermined data from a disk loaded in the recording and reproducing apparatus, the recorded predetermined data having been recorded on the disk using write strategy parameters of the recording and reproducing apparatus; a Viterbi decoder to Viterbi decode the adaptively equalized signal using a reference level; a reference level generator to generate the reference level used in the Viterbi decoder using the Viterbi decoded signal and the reproduction signal; an ideal reproduction signal generator to generate an ideal reproduction signal using the predetermined data, the Viterbi decoded signal, and the reference level; a difference detector to detect a difference between the adaptively equalized signal and the ideal reproduction signal; a selection signal generator to generate a selection signal using the predetermined data and the Viterbi decoded signal; a write strategy feedback error detector to process the difference using a predetermined function to detect a write strategy feedback error; a first memory to store the write strategy parameters; and an update unit to update the write strategy parameters stored in the first memory at an address specified by the selection signal using the write strategy feedback error.

According to an aspect of the invention, a recording and reproducing apparatus includes an adaptive equalization unit to adaptively equalize a reproduction signal obtained by reproducing recorded predetermined data from a disk loaded in the recording and reproducing apparatus, the recorded predetermined data having been recorded on the disk using write strategy parameters of the recording and reproducing apparatus; a Viterbi decoder to Viterbi decode the adaptively equalized signal using a reference level; a reference level generator to generate the reference level used in the Viterbi decoder using the Viterbi decoded signal and the reproduction signal; an ideal reproduction signal generator to generate an ideal reproduction signal using the Viterbi decoded signal and the reference level; a difference detector to detect a difference between the adaptively equalized signal and the ideal reproduction signal; a selection signal generator to generate a selection signal using the Viterbi decoded signal; a write strategy feedback error detector to process the difference using a predetermined function to detect a write strategy feedback error; a memory to store the write strategy parameters; and an update unit to update the write strategy parameters stored in the memory at an address specified by the selection signal using the write strategy feedback error.

Additional aspects and/or advantages of the invention will be set forth in part in the description that follows, and in part, will be obvious from the description, or may be learned by practice of the invention.

### BRIEF DESCRIPTION OF THE DRAWINGS

A better understanding of the invention will become apparent from the following detailed description of example embodiments of the invention and the claims when read in connection with the accompanying drawings, all forming a part of the disclosure of the invention. While the following written and illustrated disclosure focuses on disclosing example embodiments of the invention, it should be clearly understood that the same is by way of illustration and example only, and that the invention is not limited thereto. The spirit and scope of the invention are limited only by the terms of the claims and their equivalents. The following represents brief descriptions of the drawings, wherein:

FIG. 1 is a block diagram of a recording and reproducing apparatus according to an example embodiment of the invention;

FIG. 2 is a block diagram of a recording and reproducing apparatus according to an example embodiment of the invention; and

FIG. 3 is a flowchart of a method of setting a write strategy parameter according to an example embodiment of the invention.

### DETAILED DESCRIPTION OF THE EMBODIMENTS

Reference will now be made in detail to embodiments of the invention, examples of which are shown in the accompanying drawings, wherein like reference numerals refer to like elements throughout. The embodiments are described below in order to explain the invention by referring to the figures.

Aspects of the invention relate to a method of setting adaptive bitwise write strategy parameters for a disk loaded in a disk drive using an adaptive equalizer, and a recording and reproducing apparatus for performing the method.

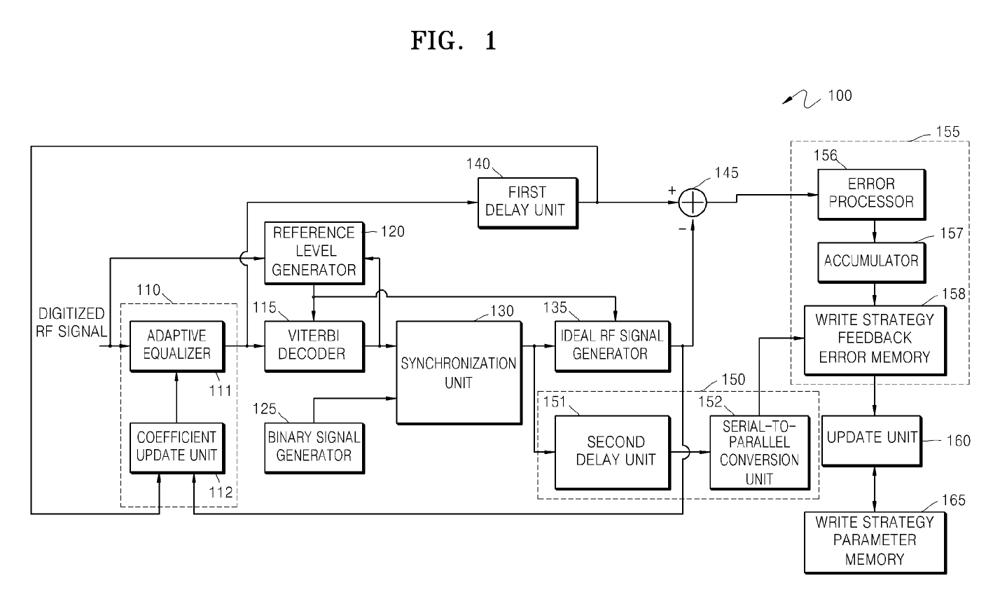

FIG. 1 is a block diagram of a recording and reproducing apparatus 100 according to an example embodiment of the invention. Referring to FIG. 1, the recording and reproducing apparatus 100 includes an adaptive equalization unit 110, a Viterbi decoder 115, a reference level generator 120, a binary signal generator 125, a synchronization unit 130, an ideal radio-frequency (RF) signal generator 135, a first delay unit 140, a difference detector 145, a selection signal generator 150, a write strategy feedback error detector 155, an update unit 160, and a write strategy parameter memory 165.

The adaptive equalization unit 110 adaptively equalizes an input digitized RF signal obtained by digitizing an RF signal reproduced from a disk (not shown) loaded in the recording and reproducing apparatus 100. The RF signal reproduced from the disk (not shown) is predetermined data in the form of a binary signal.

The adaptive equalization unit 110 includes an adaptive equalizer 111 and a coefficient update unit 112. The adaptive equalizer 111 adaptively equalizes the input digitized RF signal to remove noise, thereby improving a frequency characteristic of the input digitized RF signal. The adaptive equalizer 111 may be embodied as a finite impulse response (FIR) filter. The coefficient update unit 112 updates an equalization coefficient used by the adaptive equalizer 111 using two signals input to the difference detector 145. The two signals are an output signal of the first delay unit 140 and an output signal of the ideal RF signal generator 135.

The Viterbi decoder 115 Viterbi decodes the adaptively equalized signal output from the adaptive equalization unit 110 using a reference level, and outputs a binary signal as a result. The Viterbi decoder 115 may detect the binary signal in the signal output from the adaptive equalization unit 110 using a detection window having a length or width v. The Viterbi decoder 115 may be embodied using a partial response maximum likelihood (PRML) detection technique.

The reference level generator 120 generates a plurality of reference levels used in the Viterbi decoder 115 using the input digitized RF signal and the binary signal output from the Viterbi decoder 115. The generated reference levels are input to the Viterbi decoder 115 and the ideal RF signal generator 135.

The binary signal generator 125 generates a predetermined binary signal. The predetermined binary signal represents predetermined data recorded on the disk for use in updating write strategy parameters according to an aspect of the invention, and may be defined as a known binary signal. The RF signal reproduced from the disk that is digitized to obtain the input digitized RF signal that is input to the adaptive equalization unit 110 is an RF signal obtained by reproducing the recorded predetermined data from the disk.

The synchronization unit 130 synchronizes the predetermined binary signal generated by the binary signal generator 125 with the binary signal output from the Viterbi decoder 115. The synchronization unit 130 performs the synchronization by delaying the predetermined binary signal generated by the binary signal generator 125 using a sliding window having a width w. The width w of the sliding window corresponds to a width of a write strategy indexing bit pattern. Thus, a synchronized binary signal output from the synchronization unit 130 is the predetermined binary signal generated by the binary signal generator 125 synchronized with the binary signal output from the Viterbi decoder 115, i.e., the delayed predetermined binary signal generated by the binary signal generator 125. This synchronized binary signal has the sliding window width w. The sliding window width w is synchronized with the detection window length or width v in the Viterbi decoder 115. That is, a center of the sliding window width w is arranged to correspond to, or to be in the vicinity of, a center of the detection window length or width v. In general, the sliding window width w has a value greater than the detection window length or width v. The synchronization unit 130 may include at least one delay unit for delaying the binary signal output from the binary signal generator 125 to synchronize the predetermined binary signal generated by the binary signal generator 125 with the binary signal output from the Viterbi decoder 115.

The ideal RF signal generator 135 generates an ideal RF signal at a time kT using the reference level generated by the reference level generator 120 and the synchronized binary signal output from the synchronization unit 130. The time kT is a time expressed as k periods of a channel clock having a period T. The ideal RF signal is an ideal reproduction signal without noise representing what the adaptively equalized signal output from the adaptive equalization unit 110 should look like when the recorded predetermined data that was reproduced from the disk to obtain the RF signal that was digitized and input to the adaptive equalization unit 110 was recorded on the disk using optimum write strategy parameters for the disk. The ideal RF signal output from the ideal RF signal generator 135 is a representation of the predetermined binary signal generated by the binary signal generator 125 synchronized with the output signal of the Viterbi decoder 115 via the sliding window having the width w. For example, the ideal RF signal generator 135 generates the ideal RF signal by generating a selection signal from the synchronized binary signal output from the synchronization unit 130 by converting the serial bits of the synchronized binary signal in a sliding window to a parallel signal, and selecting one of the reference levels output from the reference level generator 120 using the selection signal. For example, if the sliding window covers 9 bits of the synchronized binary signal, the reference level generator 120 generates 2⁹=512 reference levels, and the ideal RF signal generator 135 generates a 9-bit parallel selection signal at a time kT from the 9 serial bits in the sliding window, and selects one of the 512 reference levels output from the reference level generator 120 using the 9-bit parallel selection signal as the value of the ideal RF signal at the time kT. Then, at a time (k+1)T, the ideal RF signal generator 135 shifts the sliding window by one bit, generates another 9-bit parallel selection signal from the 9 serial bits in the shifted sliding window, and selects one of the 512 reference levels as the value of the ideal RF signal at the time (k+1)T. However, it is understood that other methods of generating the ideal RF signal may be used.

The sliding window moves the synchronized binary signal by one bit for one channel clock in a recording direction. That is, a bit pattern in the sliding window at the time kT corresponds to the ideal RF signal that is being used as a reference level at the time kT.

The first delay unit 140 delays the adaptively equalized signal output from the adaptive equalizer to compensate for a time offset between the input digitized RF signal and the ideal RF signal generated by the ideal RF signal generator 135 so that the input digitized RF signal is synchronized with the ideal RF signal.

The difference detector 145 detects a difference between the delayed signal output from the first delay unit 140 and the ideal RF signal output from the ideal RF signal generator 135, and outputs the difference. The difference represents an error at the time kT between the input digitized RF signal as synchronized with the ideal RF signal and the ideal RF signal. Thus, the difference detector 145 may be defined as an error detector. The input digitized RF signal as synchronized with the ideal RF signal is an RF signal reproduced from the disk at the time kT.

The selection signal generator 150 generates a selection signal used to detect a write strategy feedback error in the write strategy feedback error detector 155 using the synchronized binary signal output from the synchronization unit 130.

The selection signal generator 150 includes a second delay unit 151 and a serial-to-parallel conversion unit 152. The second delay unit 151 delays the synchronized binary signal output from the synchronization unit 130 to compensate for a time offset between the difference output from the difference detector 145 and the synchronized binary signal. The serial-to-parallel conversion unit 152 converts the delayed synchronized binary signal output from the second delay unit 151, which is a serial signal, into a parallel signal, and outputs the parallel signal as a selection signal. The number of bits in the parallel signal is equal to the sliding window width w. For example, if the sliding window width w is 9, the serial-to-parallel conversion unit 152 converts 9 bits of the serial signal output from the second delay unit 151 into a parallel signal of 9 bits, and outputs the parallel signal as the selection signal.

The write strategy feedback error detector 155 processes the difference output from the difference detector 145 using a predetermined function and the selection signal output from the serial-to-parallel conversion unit 152, and detects the write strategy feedback error. The write strategy feedback error detector 155 includes an error processor 156, an accumulator 157, and a write strategy feedback error memory 158.

The error processor 156 processes the difference output from the difference detector 145 using the predetermined function according to the following Equation 1, and detects the write strategy feedback error.

$$F\_out ( kT ) = {\sum }_{i = [ \frac{n - 1}{2} ]}^{- [ \frac{n}{2} ]} Error ( ( k - i ) \cdot T ) \cdot f ( i ) \qquad ( 1 )$$

In Equation 1, F_out(kT) is an output signal of the error processor 156 at the time kT, Error((k−i)·T) is the difference output from the difference detector 145 at a time (k−i)T, f(i) is a predetermined weighting function, and n is a predetermined number of errors to be weighted and summed. The notation “[ ]”in the summation limits in Equation 1 denotes the floor function, also known as the greatest integer function, of a real number x, which returns the largest integer less than or equal to x. Thus, the value of [n/2] is the largest integer that is less than or equal to n/2, and the value of [(n−1)/2] is the largest integer that is less than or equal to (n−1)/2. For example [2.5]=2, and [−2.5]=−3.

The error processor 156 may be embodied as a finite impulse response (FIR) filter. If the error processor 156 is embodied as an FIR filter, f(i) in Equation 1 may be the impulse response of the channel. Also, the value n in Equation 1 may be an intersymbol interference (ISI) window length of the channel.

The accumulator 157 accumulates and stores the write strategy feedback error output from the error processor 156 in the write strategy feedback error memory 158. The write strategy feedback error memory 158 is addressed by the selection signal output from the serial-to-parallel conversion unit 152 to store an accumulated write strategy feedback error output from the accumulator 157 and an error count indicating a number of times the write strategy feedback error has been accumulated at an address designated by the selection signal output from the serial-to-parallel conversion unit 152. That is, when the selection signal output from the serial-to-parallel conversion unit 152 is an efficient write strategy indexing bit pattern, an output from the error processor 156 is accumulated as contents in a corresponding memory cell of the write strategy feedback error memory 158 by the accumulator 157, and the error count indicating the number of times the write strategy feedback error has been accumulated is stored as contents in a corresponding memory cell of the write strategy feedback error memory 158 by the accumulator 157. Each write strategy indexing bit pattern corresponds to a different write strategy feedback error. The contents of the memory cells of the write strategy feedback error memory 158 are initially set to 0. For example, if the error processor 156 outputs an error of −0.2 when the indexing bit pattern is “000011100,” the accumulator 157 reads the accumulated error of 0 and the error count of 0 from the memory cells at the address designated by “000011100,” adds the error of −0.2 to the accumulated error of 0 to obtain a new accumulated error of −0.2, increases the error count of 0 to 1, and stores the new accumulated error of −0.2 and the new error count of 1 in the memory cells at the address designated by “000011100.” Next, if the error processor 156 outputs an error of −0.3 when the indexing bit pattern is “000011100,” the accumulator 157 reads the accumulated error of −0.2 and the error count of 1 from the memory cells at the address designated by “000011100,” adds the error of −0.3 to the accumulated error of −0.2 to obtain a new accumulated error of −0.5, increases the error count of 1 to 2, and stores the new accumulated error of −0.5 and the new error count of 2 in the memory cells at the address designated by “000011100.” Next, if the error processor 156 outputs an error of −0.4 when the indexing bit pattern is “000011100,” the accumulator 157 reads the accumulated error of −0.5 and the error count of 2 from the memory cells at the address designated by “000011100,” adds the error of −0.4 to the accumulated error of −0.5 to obtain a new accumulated error of −0.9, increases the error count of 2 to 3, and stores the new accumulated error of −0.9 and the error count of 3 in the memory cells at the address designated by “000011100.”

The write strategy parameter memory 165 stores write strategy parameters for a writing pulse of one clock. If the sliding window width is w and the stored write strategy parameters include three write strategy parameters consisting of a start time of a writing pulse, an end time of the writing pulse, and a height of the writing pulse, the write strategy parameter memory 165 may store the three write strategy parameters at one address and have a capacity of 2^{w} addresses. However, it is understood that the write strategy parameters can include fewer or more than three write strategy parameters, and can include other types and/or combinations of write strategy parameters. The write strategy parameters stored in the write strategy parameter memory 165 are indexed by the same indexing bit pattern that is used to index the write strategy feedback error memory 158.

The update unit 160 updates the write strategy parameters stored in the write strategy parameter memory 165 based on the accumulated error and the accumulated count stored in the write strategy feedback error memory 158 using a predetermined updating algorithm. An example updating algorithm is as follows, wherein factor1 and factor2 are predetermined weighting factors:

new start time=start time+(factor1×(accumulated error/error count))

new end time=end time

new pulse height=pulse height+(factor2×(accumulated error/error count))

For example, if the write strategy parameters stored at the address “000011100” in the write strategy parameter memory 165 are a start time of 0.2T, an end time of 1.0T, and a pulse height of 1.0; the contents of the write strategy feedback error memory 165 at the address “000011100” are the accumulated error of −0.9 and the error count of 3 discussed above; factor1=0.1; and factor2=0.2, the update unit 160 determines a new start time of 0.17T (=0.2T+(0.1×(−0.9/3))), a new end time of 1.0T (=1.OT), and a new pulse height of 0.94 (=1.0+(0.2×(−0.9/3))), and stores the new start time, the new end time, and the new pulse height in the write strategy parameter memory 165 at the address “000011100.” However, it is understood that other updating algorithms may be used.

As described above, FIG. 1 corresponds to a case in which the ideal RF signal is generated using the predetermined binary signal for use in updating the current write strategy parameters.

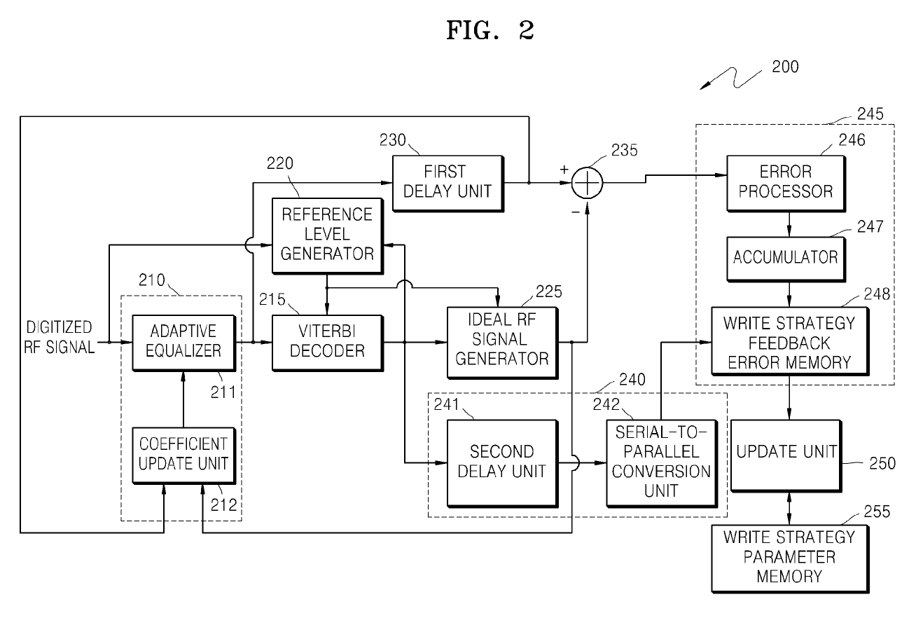

FIG. 2 is a block diagram of a recording and reproducing apparatus 200 according to an example embodiment of the invention. Referring to FIG. 2, the recording and reproducing apparatus 200 includes an adaptive equalization unit 210, a Viterbi decoder 215, a reference level generator 220, an ideal RF signal generator 225, a first delay unit 230, a difference detector 235, a selection signal generator 240, a write strategy feedback error detector 245, an update unit 250, and a write strategy parameter memory 255. The adaptive equalization unit 210 includes an adaptive equalizer 211 and a coefficient update unit 212. The selection signal generator 240 includes a second delay unit 241 and a serial-to-parallel conversion unit 242. The write strategy feedback error detector 245 includes an error processor 246, an accumulator 247, and a write strategy feedback error memory 248.

The recording and reproducing apparatus 200 of FIG. 2 is the same as the recording and reproducing apparatus 100 of FIG. 1, except that the ideal RF signal generator 225 of the recording and reproducing apparatus 200 generates an ideal RF signal using an output signal of the Viterbi decoder 215 and a plurality of reference levels generated by the reference level generator 220, while the ideal RF signal generator 135 of the recording and reproducing apparatus 100 generates an ideal RF signal using the synchronized binary signal output from the synchronization unit 130 and the plurality of reference levels generated by the reference level generator 120.

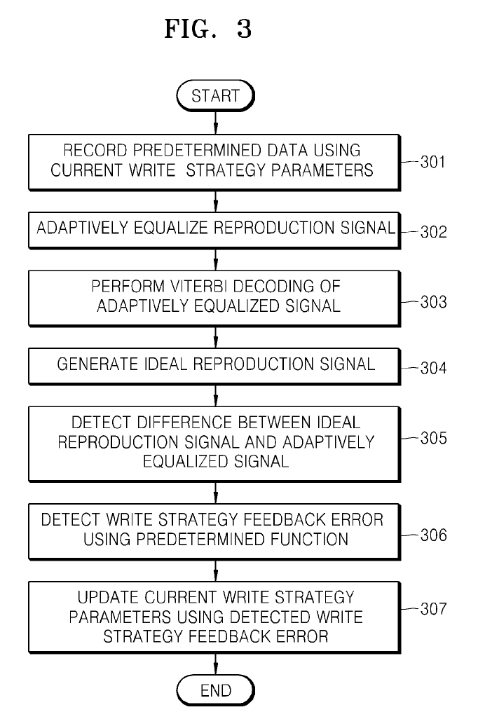

FIG. 3 is a flowchart of a method of setting write strategy parameters according to an example embodiment of the invention. Referring to FIG. 3, the method of setting write strategy parameters includes recording predetermined data in a predetermined area of a disk (not shown) loaded in a disk drive using write strategy parameters of the disk drive (operation 301). The predetermined data is equivalent to the predetermined binary signal described with reference to FIG. 1. The write strategy parameters may be indexed using a bitwise write strategy indexing method.

Next, a reproduction signal obtained by reproducing the recorded predetermined data from the disk (not shown) in operation 301 is adaptively equalized, like the adaptive equalization performed by the adaptive equalization unit 110 of FIG. 1 (operation 302). Next, the adaptively equalized signal is Viterbi decoded (operation 303).

Next, an ideal reproduction signal is generated (operation 304). The ideal reproduction signal may be generated using the predetermined data synchronized with the Viterbi decoded signal, and a reference level used in the Viterbi decoding as shown in FIG. 1. Alternatively, the ideal reproducing signal may be generated using the Viterbi decoded signal and the reference level used in the Viterbi decoding without using the predetermined data as shown in FIG. 2.

Next, a difference is detected between the ideal reproduction signal and the adaptively equalized signal (operation 305). Next, the difference is processed using a predetermined function according to Equation 1 as discussed above in connection with FIG. 1 to detect a write strategy feedback error (operation 306). The current write strategy parameters are updated using the detected write strategy feedback error (operation 307).

Aspects of the invention relate to improving a frequency characteristic of a signal reproduced from a disk loaded in a disk drive using an adaptive equalizer to remove noise, thereby obtaining a reproduction signal, and using the reproduction signal in setting of bitwise write strategy parameters. By doing so, aspects of the invention can provide a disk drive or a recording and reproducing apparatus having a good recording quality for various types of disks.

A program for executing the method of setting the write strategy parameters according to aspects of the invention can be embodied as computer-readable code recorded on a computer-readable recording medium. The computer-readable recording medium may be any data storage device that can store data, which can be thereafter read by a computer. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion.

While there have been shown and described what are considered to be example embodiments of the invention, it will be understood by those skilled in the art and as technology develops that changes and modifications may be made in these example embodiments, and equivalents may be substituted for elements thereof, without departing from the true scope of the invention. Many modifications, permutations, additions and sub-combinations may be made to adapt the teachings of the invention to particular situations without departing from the scope thereof. Accordingly, it is intended, therefore, that the invention not be limited to the various example embodiments disclosed herein, but include all embodiments falling within the scope of the claims and their equivalents.

What is claimed is:

1. A method of setting write strategy parameters in a disk drive comprising a memory having write strategy parameters stored therein, the method comprising:
recording predetermined data on a disk loaded in the disk drive using the write strategy parameters stored in the memory;
adaptively equalizing a reproduction signal obtained by reproducing the recorded predetermined data from the disk;
Viterbi decoding the adaptively equalized signal using a reference level;
generating an ideal reproduction signal using the predetermined data, the Viterbi decoded signal, and the reference level used in the Viterbi decoding;
detecting a difference between the adaptively equalized signal and the ideal reproduction signal;
generating a selection signal using the predetermined data and the Viterbi decoded signal;
processing the difference using a predetermined function to detect a write strategy feedback error; and
updating the write strategy parameters stored in the memory at an address specified by the selection signal using the write strategy feedback error.

2. The method of claim 1, wherein the predetermined writing strategy parameters stored in the memory are indexed using a bitwise write strategy indexing method.

3. The method of claim 1, wherein the adaptive equalizing comprises updating an equalization coefficient used in the adaptive equalizing using the ideal reproduction signal and the adaptively equalized signal.

4. The method of claim 1, wherein the detecting of the write strategy feedback error is performed using a finite impulse response (FIR) filter and an accumulator.

5. The method of claim 1, wherein the ideal reproduction signal represents what the adaptively equalized signal should look like when the recorded predetermined data that was reproduced from the disk to obtain the reproduction signal that was adaptively equalized was recorded on the disk using optimum write strategy parameters.

6. The method of claim 1, wherein the processing of the difference is performed according to the following equation:
$$F\_out ( kT ) = {\sum }_{i = [ \frac{n - 1}{2} ]}^{- [ \frac{n}{2} ]} Error ( ( k - i ) \cdot T ) \cdot f ( i )$$
where F_out(kT) is the write strategy feedback error at a time kT expressed as k periods of a channel clock having a period T, Error((k−i)·T) is the difference at a time (k−i)T, f(i) is a predetermined weighting function, n is a predetermined number of errors to be weighted and summed, and [ ] denotes a floor function of a real number x, which returns the largest integer less than or equal to x.

7. A method of setting write strategy parameters in a disk drive comprising a memory having write strategy parameters stored therein, the method comprising:
recording predetermined data on a disk loaded in the disk drive using the write strategy parameters stored in the memory;
adaptively equalizing a reproduction signal obtained by reproducing the recorded predetermined data from the disk;
Viterbi decoding the adaptively equalized signal using a reference level;
generating an ideal reproduction signal using the Viterbi decoded signal and the reference level used in the Viterbi decoding;
detecting a difference between the adaptively equalized signal and the ideal reproduction signal;
generating a selection signal using the Viterbi decoded signal;
processing the difference using a predetermined function to detect a write strategy feedback error; and
updating the write strategy parameters stored in the memory at an address specified by the selection signal using the write strategy feedback error.

8. The method of claim 7, wherein the ideal reproduction signal represents what the adaptively equalized signal should look like when the recorded predetermined data that was reproduced from the disk to obtain the reproduction signal that was adaptively equalized was recorded on the disk using optimum write strategy parameters.

9. The method of claim 7, wherein the processing of the difference is performed according to the following equation:
$$F\_out ( kT ) = {\sum }_{i = [ \frac{n - 1}{2} ]}^{- [ \frac{n}{2} ]} Error ( ( k - i ) \cdot T ) \cdot f ( i )$$
where F_out(kT) is the write strategy feedback error at a time kT expressed as k periods of a channel clock having a period T, Error((k−i)·T) is the difference at a time (k−i)T, f(i) is a predetermined weighting function, n is a predetermined number of errors to be weighted and summed, and [ ] denotes a floor function of a real number x, which returns the largest integer less than or equal to x.

10. A recording and reproducing apparatus comprising:
an adaptive equalization unit to adaptively equalize a reproduction signal obtained by reproducing recorded predetermined data from a disk loaded in the recording and reproducing apparatus, the recorded predetermined data having been recorded on the disk using write strategy parameters of the recording and reproducing apparatus;
a Viterbi decoder to Viterbi decode the adaptively equalized signal using a reference level;
a reference level generator to generate the reference level used in the Viterbi decoder using the Viterbi decoded signal and the reproduction signal;
an ideal reproduction signal generator to generate an ideal reproduction signal using the predetermined data, the Viterbi decoded signal, and the reference level;
a difference detector to detect a difference between the adaptively equalized signal and the ideal reproduction signal;
a selection signal generator to generate a selection signal using the predetermined data and the Viterbi decoded signal;
a write strategy feedback error detector to process the difference using a predetermined function to detect a write strategy feedback error;
a first memory to store the write strategy parameters; and
an update unit to update the write strategy parameters stored in the first memory at an address specified by the selection signal using the write strategy feedback error.

11. The recording and reproducing apparatus of claim 10, wherein the write strategy parameters stored in the first memory are indexed using a bitwise write strategy indexing method.

12. The recording and reproducing apparatus of claim 10, wherein the write strategy feedback error detector comprises:
a finite impulse response (FIR) filter to filter the difference to obtain the write strategy feedback error;
an accumulator to accumulate the write strategy feedback error; and
a second memory to store the accumulated write strategy feedback error.

13. The recording and reproducing apparatus of claim 10, wherein the adaptive equalization unit comprises:
an adaptive equalizer to adaptively equalize the reproduction signal; and
a coefficient update unit to update an equalization coefficient of the adaptive equalizer using the ideal reproduction signal and the adaptively equalized signal.

14. The recording and reproducing apparatus of claim 10, wherein the ideal reproduction signal represents what the adaptively equalized signal should look like when the recorded predetermined data that was reproduced from the disk to obtain the reproduction signal that was adaptively equalized was recorded on the disk using optimum write strategy parameters.

15. The recording and reproducing apparatus of claim 10, wherein the write strategy feedback error detector processes the difference according to the following equation:
$$F\_out ( kT ) = {\sum }_{i = [ \frac{n - 1}{2} ]}^{- [ \frac{n}{2} ]} Error ( ( k - i ) \cdot T ) \cdot f ( i )$$
where F_out(kT) is the write strategy feedback error at a time kT expressed as k periods of a channel clock having a period T, Error((k−i)·T) is the difference at a time (k−i)T, f(i) is a predetermined weighting function, n is a predetermined number of errors to be weighted and summed, and [ ] denotes a floor function of a real number x, which returns the largest integer less than or equal to x.

16. A recording and reproducing apparatus comprising:
an adaptive equalization unit to adaptively equalize a reproduction signal obtained by reproducing predetermined recorded data from a disk loaded in the recording and reproducing apparatus, the recorded predetermined data having been recorded on the disk using write strategy parameters of the recording and reproducing apparatus;
a Viterbi decoder to Viterbi decode the adaptively equalized signal using a reference level;
a reference level generator to generate the reference level used in the Viterbi decoder using the Viterbi decoded signal and the reproduction signal;
an ideal reproduction signal generator to generate an ideal reproduction signal using the Viterbi decoded signal and the reference level;
a difference detector to detect a difference between the adaptively equalized signal and the ideal reproduction signal;
a selection signal generator to generate a selection signal using the Viterbi decoded signal;
a write strategy feedback error detector to process the difference using a predetermined function to detect a write strategy feedback error;
a memory to store the write strategy parameters; and
an update unit to update the write strategy parameters stored in the memory at an address specified by the selection signal using the write strategy feedback error.

17. The recording and reproducing apparatus of claim 16, wherein the ideal reproduction signal represents what the adaptively equalized signal should look like when the recorded predetermined data that was reproduced from the disk to obtain the reproduction signal that was adaptively equalized was recorded on the disk using optimum write strategy parameters.

18. The recording and reproducing apparatus of claim 16, wherein the write strategy feedback error processes the difference according to the following equation:
$$F\_out ( kT ) = {\sum }_{i = [ \frac{n - 1}{2} ]}^{- [ \frac{n}{2} ]} Error ( ( k - i ) \cdot T ) \cdot f ( i )$$
where F_out(kT) is the write strategy feedback error at a time kT expressed as k periods of a channel clock having a period T, Error((k−i)·T) is the difference at a time (k−i)T, f(i) is a predetermined weighting function, n is a predetermined number of errors to be weighted and summed, and [ ] denotes a floor function of a real number x, which returns the largest integer less than or equal to x.
